(19) United States
(12) Patent Application Publication
(10) Pub. No.: US 2012/0156385 A1
(43) Pub. Date: Jun. 21, 2012

(54) Use Of Aqueous Wax Dispersions And Method For Improving The Mechanical Properties Of Textile Fibers

(75) Inventors: Jürgen Falkowski, Monheim (DE); Karlheinz Hill, Erkrath (DE); Rita Köster, Dusseldorf (DE); Josefine Schröder, Erkelenz (DE); Manfred Weuthen, Langenfeld (DE)

(73) Assignee: Cognis IP Management GmbH, Düsseldorf (DE)

(21) Appl. No.: 13/379,861

(22) PCT Filed: Jun. 19, 2010
(86) PCT No.: PCT/EP2010/003710

§ 371 Date: Mar. 5, 2012

(30) Foreign Application Priority Data
Jun. 27, 2009 (EP) 09008431.0

(51) Int. Cl. B05D 1/18

(52) U.S. Cl. 427/430.1

(57) ABSTRACT

Provided are the application of waxes, preferably in the form of aqueous wax dispersions comprising a dispersing agent (a) and a wax component (b) and optionally additional auxiliary and additive materials (c). The mechanical properties of textile fibers treated with these aqueous wax dispersion compositions are improved. In particular, the tear resistance of the textile fibers are improved.

The present invention relates to a method for improving the mechanical properties of textile fibers.

Laundry detergent and cleaning products are produced in large volumes for the benefit of the consumer. They are mainly used for cleaning textile fabrics and hard surfaces in the home and the industrial/institutional sector. The laundry detergent and cleaning products in question can be produced in solid form, usually as powder or granules, or in liquid form. Liquid formulations have increasingly won favor with the consumer in recent years owing to their greater ease of use. In addition, liquid laundry detergent and cleaning products are simpler and less energy-intensive to produce, which is an additional motivation for the producers of laundry detergent and cleaning products. The main ingredients of liquid laundry detergent and cleaning products are water; the detersive substances, also called surfactants; the builder system; solubility improvers; specific additives, such as soil anti-redeposition agents or color transfer inhibitors; the enzyme system; the perfume oils; and possibly also preservatives and dyes.

It is also known, furthermore, that textiles are actually damaged by the act of wearing them, but especially in the course of being washed. In washing, this can be due either to chemical influences, for example oxidizing bleaches, washing alkalis or else the water itself, which causes severe swelling of the fibers in the case of cotton for example. In addition, the textiles are damaged mechanically by the agitation in the washing machine or by scuffing and creasing in the course of wear. The two mechanisms of inflicting damage can also overlap, for example in the case of fibers bearing deposits due to the calcium and magnesium hardness of the wash water, such as sparingly soluble alkaline earth metal phosphates for example, additionally rubbing against each other in the course of a wash. Light duty laundry detergents in particular already contain additives for preserving the textiles in the course of washing. Examples include surfactant systems with a more powerful or more finely porous foaming action, which surround the textiles with a layer of foam during the wash. Another possibility is to use in liquid laundry detergents certain cationic surfactants that are also used in rinse cycle fabric conditioners. These cationic surfactants, examples of which are cetyltrimethylammonium chloride and triethanolamine-based esterquats, are by virtue of their cationic charge substantive on cellulosic textiles, especially cotton, and are capable of reducing fiber-against-fiber friction. It is also known to use particular cationic polymers or silicone compounds for this purpose. The disadvantage of cationic compounds is their interaction with anionic surfactant systems, which are preferentially used in liquid laundry detergents owing to their good price/performance ratio. This interaction then frequently leads to a significant deterioration in washing performance. Therefore, these cationic compounds can usually only be incorporated in nonionic surfactant systems which, however, usually have an altogether worse washing performance than the nonionic/anionic-based laundry detergent formulations.

The problem addressed by the present invention was therefore that of providing a method whereby mechanically and/or chemically damaged textile fibers can be improved in their strength, and/or a method for preventing damage to textile fibers due to laundry detergents or laundering processes.

It was found that the application of certain aqueous wax dispersions to the textile fibers are capable of solving the problem.

A first aspect of the present application accordingly relates to a method for improving the mechanical properties of textile fibers by applying to the fibers aqueous compositions comprising in addition to water at least (a) alkyl(oligo)glycosides together with (b) a mixture of mono- and diesters of saturated and unsaturated fatty acids having 16 to 22 carbon atoms with diols and polyols, and optionally (c) further auxiliary and added substances.

The mechanical properties of fibers can be damaged for example by measuring the decrease in rupturing strength. There are various textile testing methods for this, which are described in the appropriate DIN standards (DIN EN ISO 13934-1 Determination of maximum force using the strip method, DIN EN ISO 13937-2 Determination of tear force of trouser-shaped test specimens, DIN EN ISO 13934-2 Determination of maximum force using the grab method, DIN EN ISO 13937-1 Determination of tear force using ballistic pendulum method (Elmendorf)). Chemically caused damage to fibers in cellulosic fabrics, especially cotton, can be assessed for example by measuring the degree of polymerization after dissolution in a standardized EWN solution and determining the viscosity. The use of the wax dispersions according to the invention leads to an improvement—and thus an increase in the rupturing strength and a reduction in the tear tendency—compared with untreated textile fibers in each case. This advantageous effect occurs preferentially in the case of cellulosic fibers and/or wool fibers. The wax dispersions are further useful for improving the mechanical properties of textile fibers in general and preferentially for reducing their tongue tear tendency and/or increasing their tensile strength.

A textile fiber is any fiber capable of being processed by textile methods of processing. Textile fibers share the feature of having a long length relative to their cross section as well as adequate strength and flexibility. Textile fibers treated using the method according to the invention may consist of natural fibers or of synthetic fibers or of blend systems or contain same.

Textile fibers consisting wholly or partly, but preferably to an extent of more than 30%, of natural fibers, such as wool or cotton, are particularly preferable. In addition to the individual fibers it is of course the case that textile sheet products containing these fibers, e.g., garments, are also amenable to the method claimed herein.

The aqueous compositions for use in the method according to the invention, in addition to water, mandatorily also contain the two components (a) and (b) side by side. Component (a) preferably comprises alkyl-(oligo)glycosides and component (b) preferably comprises mixtures of esters based on diols/polyols with selected fatty acids. The compositions themselves are wax dispersions, i.e., water-insoluble wax is present in the compositions in a finely dispersed form—the term dispersion also comprehends emulsions and solutions.

Component (a)

The wax dispersions mandatorily contain—in order that the water-insoluble or sparingly water-soluble wax components may be kept in solution—dispersants or emulsifiers, preferably nonionic, anionic emulsifiers or mixtures of nonionic and anionic emulsifiers. The use of cationic emulsifiers, for example ethoxylated or propoxylated fatty amines or quaternized amine compounds is likewise possible if the wax dispersions are to be used in specific laundry or rinse cycle fabric conditioner formulations containing esterquats for example.

Nonionic emulsifiers may be ethoxylated or propoxylated products, for example ethoxylated or propoxylated fatty alcohols, fatty acids or fatty amines. In addition, ethylene oxide-free emulsifiers can also be used, examples being glycerol esters, carbohydrate esters or sugar esters, methylglucoside esters or alkylpolyglucosides. The latter are particularly preferred emulsifiers for the purposes of the present invention: alkyl- and/or alkenyloligoglycosides are known nonionic surfactants conforming to formula (I),

R¹O-[G]ₚ (I)

where R¹ represents an alkyl and/or alkenyl radical of 4 to 22 carbon atoms, G represents a sugar residue of 5 or 6 carbon atoms and p represents numbers from 1 to 10. They are obtainable by the pertinent methods of preparative organic chemistry. The alkyl- and/or alkenyloligoglycosides can derive from aldoses/ketoses having 5 or 6 carbon atoms, preferably from glucose. The preferred alkyl- and/or alkenyloligoglycosides are thus alkyl- and/or alkenyloligoglucosides. The index number p in the general formula (I) indicates the degree of oligomerization (DP), i.e., the distribution of mono- and/or oligoglycosides, and represents a number between 1 and 10. While p in a given compound always has to be a whole number and may here especially assume the values of p=1 to 6, the value p of a particular alkyloligoglycoside is an analytically determined arithmetic variable which usually constitutes a fractional number. Preference is given to using alkyl- and/or alkenyloligoglycosides having an average degree of oligomerization p in the range from 1.1 to 3.0. Alkyl- and/or alkenyloligoglycosides preferred from an application engineer's point of view have a degree of oligomerization less than 1.7 and especially between 1.2 and 1.4. The alkyl or alkenyl radical R¹ may derive from primary alcohols having 4 to 11, preferably 8 to 10 carbon atoms. Typical examples are butanol, hexyl alcohol, caprylic alcohol, decyl alcohol and undecyl alcohol and also their technical grade mixtures, as obtained for example in the hydrogenation of technical grade fatty acid methyl esters or in the course of hydrogenating aldehydes from Roelen's oxo process. Preference is given to alkyloligoglucosides of chain length C₈-C₁₀ (DP=1 to 3), which are generated as a forerun in the distillative separation of technical grade C₈-C₁₈ coconut fatty alcohol and may contain less than 6% by weight of C₁₂ alcohol as an impurity, and also alkyloligoglucosides based on technical grade C_{9/11} oxo process alcohols (DP=1 to 3). The alkyl or alkenyl radical R¹ may further also derive from primary alcohols having 12 to 22, preferably 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and also their technical grade mixtures, which are obtainable as described above. Preference is given to alkyloligoglucosides based on hydrogenated C_{12/14} cocoalcohol having a DP of 1 to 3.

Component (a) may further be an anionic emulsifier or a blend of anionic and nonionic emulsifiers. Anionic emulsifiers may be for example saturated or unsaturated fatty alcohol sulfates, in which case the fatty alcohols may contain 8 to 22 carbon atoms, preferably to 18 carbon atoms. Fatty alcohol ether sulfates, alkylbenzene sulfates, sulfonated fatty acids or methyl esters or sulfosuccinates can also be used for example.

Component (b)

The wax dispersions according to the invention contain waxes as component (b). The waxes can be based on renewable raw materials or they can be products based on petrochemical raw materials.

Preference is given to waxes based on renewable raw materials, i.e., especially waxes obtainable by esterification, transesterification, etherification or amidation for example. These processes may utilize for example comparatively long-chain fatty acids, fatty alcohols and fatty amines, preferably with carbon chains of C6-C22. But it is also possible to combine long-chain fatty acids, fatty acid chlorides, fatty alcohols or fatty amines with short-chain, mono- or polyfunctional carboxylic acids, alcohols or amine compounds, amino carboxylic acids, hydroxylamine compounds, i.e., for example ethanol, n-butanol, ethylene glycol, diethylene glycol, glycerol, triethanolamine, aminoethylethanolamine. The melting point of these waxes is preferably between 20° C. and 120° C., more preferably between 30° C. and 80° C. Examples mentioned without claim to completeness are butyl stearate, cetyl palmitate, ethylene glycol distearate, glycerol monostearate, stearyl citrate, triethanolamine distearate, stearyl glutamate, di-n-cetyl ether and di-n-stearyl ether.

It is further also preferable to use waxes based on petrochemical foundation stocks. These include for example simple hydrocarbonaceous compounds, such as paraffin waxes, or else polymerization-produced homopolymers, such as polyethylenes, polyvinyl acetates, polyacrylates, oxidized homopolymers, for example oxidized polyethylenes, copolymers based on ethylene-acrylic acid, ethylene-propylene-maleic anhydride, ethylene-vinyl acetate, or micronized polyethylene waxes. The melting point of these compounds is preferably between 40° C. and 160° C., more preferably between 60° C. and 140° C. Examples which may be mentioned—again without claim to completeness—are a few commercial products: AC330, AC 175, AC 5120, ACumist A12 from Honeywell, Licowax PE 130, Licowax PED 521, Licowax PED 192 from Clariant, Luwax OA3 wax from BASF. It is further possible to use commercial products wherein the polyethylene wax is already dispersed in aqueous solutions with anionic, nonionic or cationic emulsifiers, for example Polyquart CCE from Cognis.

It is further also possible to produce blends of waxes, not only of waxes based on renewable raw materials, but also blends of petrochemical waxes and blends of waxes based on renewable raw materials and petrochemical waxes.

Preferably, however, component (b) in turn consists of multiple, different components, viz., on the one hand esters of diols, preferably of glycol or its oligo-/polymers, and on the other esters of polyols, preferably esters of glycerol, in which case these glycerol esters are preferably used in the form of their partial esters, i.e., as mono- and/or diesters. Diol esters for the purposes of the present technical teaching include especially the esters of diols, preferably of glycol and its oligomers/polymers. Polyethylene glycols are useful as oligomers and ethylene glycols having molecular weights of 100 or more, preferably 100 to 1000, as polymers. They are esterified with fatty acids in a conventional manner. Saturated fatty acids having 16 to 22 carbon atoms are used, stearic acid being particularly preferred. A glycol stearic acid diester is a particularly preferred diester component. Fatty acid partial glycerides, i.e., monoglycerides, diglycerides and their technical grade mixtures may further contain small amounts of di- and triglycerides from the production process. Small amounts is to be understood as meaning that preferably just 1% to not more than 10% by weight, especially to not more than 5% by weight, all based on the total amount of glycerides, is accounted for by triglycerides.

Preference is given to using such glycerides (i.e., also what can in effect be mixtures of di- and monoglycerides) which are free of triglycerides. But the partial glycerides preferably conform to formula (II),

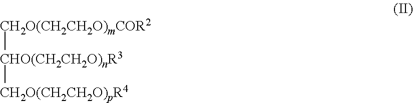

where R²CO represents a linear or branched, saturated and/or unsaturated acyl radical having 6 to 22, preferably 12 to 18 carbon atoms, R³ and R⁴ independently represent R²CO or OH and the sum (m+n+p) represents 0 or numbers from 1 to 100, preferably 5 to 25, with the proviso that at least one of R³ and R⁴ is OH. Typical examples are mono- and/or diglycerides based on caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselic acid, linoleic acid, linolenic acid, elaeostearic acid, arachadic acid, gadoleic acid, behenic acid and erucic acid and also technical grade mixtures thereof. Preference is given to using technical grade lauric acid glycerides, plamitic acid glycerides, stearic acid glycerides, isostearic acid glycerides, oleic acid glycerides, behenic acid glycerides and/or erucic acid glycerides which each have a monoglyceride content in the range from 50% to 95%, preferably 60% to 90% by weight. Especially comparatively long-chain partial glycerides e.g. based on oleic acid or stearic acid are used especially mixtures of glycerides based on saturated and unsaturated fatty acids.

The partial esters according to the above description are preferably used as a mixture of mono- and diesters of glycerol with saturated and unsaturated fatty acids each having 16 to 22 carbon atoms. Palmitic acid and stearic acid are again of particular importance as saturated fatty acid, while especially oleic acid must be selected as unsaturated fatty acid. Preference is accordingly given to compositions which, in the mixture of component b), contain glycerol partial esters based on palmitic/stearic acid and oleic acid side by side. Components a) and d) of the compositions according to the invention are preferably in a weight ratio of 1:3 to 3:1, preferably 1:3 to 1:1 and especially 1:2 to 1:1. The weight of component b) here is based on all the above-identified ingredients, i.e., not only the diesters of diols but also the partial esters based on polyols, preferably glycerol. It is further deemed preferable to use compositions that contain the components (a) and (b) together in an amount of 0.1% to 15% by weight, especially in amounts of 0.5% to 10% by weight, but preferably 1% to 5% by weight. The compounds according to the description concerning component b) are preferably water insoluble, meaning their solubility in water at 21° C. is less than 10% especially less than 5% by weight.

Useful wax compounds further include esters of synthetic polyols, for example trimethylolpropane, pentaerythritol, dipentaerythritol or neopentylglycol. Again, products fully esterified with saturated or unsaturated fatty acids as well as partially esterified products can be used for preparing the wax dispersions. In addition, wax compounds from naturally occurring polyols, for example sucrose, glucose, methyl glucoside, sorbitan can also be used, as well as once again products fully esterified with saturated or unsaturated fatty acids or else as partially esterified products.

In addition, comparatively long-chain fatty acids, fatty alcohols, hydrocarbons and fatty amines, preferably with carbon chains of C6-C22, produced synthetically or produced on the basis of renewable raw materials can be used for example not only as sole wax component but also in admixture with above-described possible compounds of component (b).

Component c)

The compositions according to the invention, in addition to water and the mandatory components (a) and (b), may optionally additionally comprise further auxiliary/added substances. Thickeners for example can be used as auxiliary or added substances. Polymeric thickeners are typically selected from the groups of polyvinyl alcohols, polyacrylic acid and polymethacrylic acids and also their salts, polyacrylamides, polyvinylpyrrolidones, polyethylene glycols, styrene-maleic anhydride copolymers and also their salts. Especially polymers having thickener properties, preferably those on an acrylate and (meth)acrylate basis are preferred. Co- or terpolymers can be used as well as homopolymers. Thickeners based on cellulose or its derivatives can also be used with success for the purposes of the present technical teaching. Examples of such thickeners are hydroxyethylcellulose, carboxymethylcellulose, hydroxypropylmethylcellulose, hydroxypropylcellulose or ethylhydroxyethylcellulose. It may further be preferable to use polyethylene glycols, preferably those having molecular weights of 100 or more, especially having a molecular weight of 100 to 500 additionally or as sole component (c).

As component (c) there may also be used polymers formed from cationic, anionic or nonionic monomers but also polymers from mixtures of cationic and nonionic monomers or mixtures of anionic and nonionic monomers. Amphoteric polymers formed from cationic, anionic and nonionic monomers can also be used. Purely synthetic polymers are in principle preferable for the purposes of the present teaching. But it is also possible to use partly synthetic polymers wherein synthetic monomers are graft-polymerized onto a core polymeric scaffold derived from natural monomeric building blocks present in starch for example.

Useful cationic monomers for this include for example N,N-dimethylaminoethyl acrylates, N,N-dimethylaminomethycrylates (DMAM), N,N-dimethylaminopropyl acrylamide (DMAPA), N,N-dimethylaminopropyl methacrylate (DMAPMA), methacrylamidopropyltrimethylammonium chloride (MAPTAC) or vinylamines, vinylimidazolines or quaternized vinylimidazolines.

Useful nonionic monomers include for example acrylamide, N,N-dialkylacrylamide, methacrylamide, C1-C12 alkyl acrylate, C1-C12 alkyl methacrylate, C1-C12 hydroxyethyl acrylates, vinylformamides, vinyl acetate and vinyl alcohol.

Useful anionic monomers include acrylic acid, methacrylic acid, vinylsulfonic acid, maleic acid or acrylamidopropylmethanesulfonic acid (AMPS).

A specific embodiment of the present invention preferably utilizes amphoteric polymers wherein the number of cationic monomers is greater than the number of anionic monomers in the molecule, and so the polymer has a small net cationic charge. Therefore, the amphoteric polymers present then preferably have a cationic charge density between 0.01 and 15 mmol/g, especially between 0.1-5 mmol/g. The advantage with using these polymers is that the washing performance is not reduced by the amphoteric polymers additionally used and only negligible soil redeposition effects occur, if any.

Perfumes, dyes, further surfactants and/or nonaqueous solvents may also be included.

Component c) is used in the wax dispersions used according to the invention in amounts of preferably 1% to 25% by weight, preferably 2% to 20% by weight and more preferably of 5% to 18% by weight. It may at this point be emphasized once more, however, that component c) is optional and thus is also completely omittable, if desired.

The method according to the invention preferably utilizes compositions containing no additional cationic or other softening substances, although in exceptional cases it may be entirely possible for compounds of this type to be used as well. In such cases, it is especially textile softeners from the family of quaternized ammonium compounds and of these especially the so-called esterquats which are preferred. The co-use of surfactants is not subject to any drastic restriction; on the contrary, any nonionic anionic, amphoteric or cationic surfactants known to a person skilled in the art can be used, although the emphasis can be on the co-use of otherwise customary further nonionic surfactants such as, for example, fatty alcohol or fatty acid alkoxylates and/or derivatives thereof.

Compositions containing the preferred components (a) and (b) are already known from the commonly assigned EP 1 972 717 A1 application, although there the use of these compositions for improving the sensory properties of textiles is described, not for improving their mechanical properties. The wax dispersions are prepared in a conventional manner, i.e., for example by stirring the individual components together with water, preferably at elevated temperatures.

The particles of wax which are dispersed in the aqueous liquor during the application process transfer to the washed or treated textiles during the application process, according to the present technical teaching. Application may be effected for example by simply contacting the textile fabrics—preferably at temperatures of 30 to 90° C.—with the wax dispersion or else in the course of a washing process, for example in a (domestic clothes) washing machine. It is preferable here to employ a washing process wherein a laundry detergent, preferably a light duty laundry detergent, is used in addition to the wax dispersion. But the present teaching also comprehends the embodiment wherein the wax dispersion alone is applied to the textile.

The amounts transferred here greatly depend on further recipe constituents of the laundry detergents. Especially the presence of charged or uncharged polymers or cationic surfactants can have a marked influence here. In addition, the material and the weave of the washed textiles also influence the degree of wax particle transfer. Measurements performed in this regard in various liquid laundry detergents incorporating for example 3% by weight of the wax dispersion generally revealed active levels of 0-100 ppm of wax on the treated textiles following 20 consecutive wash cycles.

It may be advantageous to perform the application process multiple times in succession in order that an effective quantity of waxes may be applied to the fiber surface. Typical values lie between 2 and 25 fold repetition. Typical amounts of waxes on the fiber surfaces after completion of the application process lie in the range from 10 to 1000 ppm, but preferably from 50 to 350 ppm and especially from 100 to 200 ppm. These add-on levels are distinctly different from the add-on levels customary in the textile industry for fiber finishing, which are in the region of more than 1000 ppm and typically range from 2000 to 5000 ppm. But it is a significant advantage of the method described herein that but a comparatively low amount of wax add-on on the treated fibers does provide a demonstrable effect in respect of the mechanical properties.

It may further be advantageous when, following the application of the wax dispersions to the textile, the textile is dried, and preferably the dried textile is subjected to a heat treatment. This heat treatment can take the form for example of a hot-pressing operation, or of heating the textile with hot air, for example in a laundry dryer, or in the drying cycle of a washing machine. The temperatures for the heat treatment should be in the range from 30 to 120° C., although the temperature range from 30 to 80 and especially from 35 to 65° C. may be preferable.

The amount of wax dispersion added is preferably between 0.1% by weight-10% by weight based on the amount of liquid laundry detergent used, more preferably between 1% by weight-5% by weight.

Furthermore, the wax dispersions within the meaning of the present teaching may preferably be used as constituents of conventional laundry detergent or cleaning products, especially as a constituent of light duty laundry detergents and here more preferably as a constituent of liquid laundry detergents and especially of liquid light duty laundry detergents. Light duty laundry detergents within the meaning of the present teaching, in contradistinction to fully built, heavy duty laundry detergents, do not contain any brighteners and bleaches. The liquid laundry detergents obtainable within the meaning of the invention may optionally also include a nonaqueous portion ranging from 5% to 50% and preferably 15% to 35% by weight. In the simplest case, however, aqueous solutions of the surfactant mixtures mentioned are concerned.

However, the wax dispersions according to the invention can also be incorporated in pulverulent form, i.e., products containing little or no water. This can be done for example by adding/admixing the wax dispersion into a liquid laundry detergent formulation, which is then subsequently spray dispensed. It is further also possible to dose/spray a concentrated aqueous wax dispersion, or the molten wax itself, into a granular laundry detergent. This can be done for example in a Lödige mixer, and has the advantage that only component (b), i.e., the actual wax, is dosed, which accordingly results in lower costs in respect of the raw materials.

The present application also comprehends the teaching whereby the wax is not applied in the form of an aqueous emulsion and instead the wax is dosed as such (i.e., separately) to an aqueous liquor that already contains the textile to be treated and the emulsifiers/dispersants needed for dispersal and emulsification respectively.

The laundry detergents which, within the meaning of the present technical teaching, are used together with the dispersed/emulsified waxes may, in addition to the surfactants already mentioned above, further contain other typical ingredients, for example solvents, hydrotopes, bleaches, bleach catalysts, builders, viscosity regulators, enzymes, enzyme stabilizers, optical brighteners, soil repellants, foam inhibitors, inorganic salts, polymers, and also fragrance and dye substances.

Useful organic solvents include for example mono- and/or polyfunctional alcohols having 1 to 6 carbon atoms, preferably having 1 to 4 carbon atoms. Preferred alcohols are ethanol, 1,2-propanediol, glycerol and also mixtures thereof. The compositions do preferably contain from 2% to 20% by weight and especially from 5% to 15% by weight of ethanol or any desired mixture of ethanol and 1,2-propanediol or especially of ethanol and glycerol. It is similarly possible for the preparations to contain—either in addition to the mono- and/or polyfunctional alcohols having 1 to 6 carbon atoms or alone—polyethylene glycol having a relative molecular mass between 200 and 2000, preferably up to 600 in amounts of 2% to 17% by weight. Useful hydrotopes include for example toluenesulfonate, xylenesulfonate, cumenesulfonate or mixtures thereof.

Compounds useful as bleaches because they yield hydrogen peroxide in water include the particularly important representatives sodium perborate tetrahydrate and sodium perborate monohydrate. Further examples of bleaches are peroxycarbonate, citrate perhydrates and also salts of peracids, such as perbenzoates, peroxyphthalates or diperoxydodecanedioic acid. They are typically used in amounts of 8% to 25% by weight. Preference is given to the use of sodium perborate monohydrate in amounts of 10% to 20% by weight and especially of 10% to 15% by weight. Owing to its ability to bind free water by forming the tetrahydrate, it contributes to enhancing the stability of the composition. Preferably, however, the preparations are free of bleaches of this type.

Suitable builders are ethylenediaminetetraacetic acid, nitrilotriacetic acid, citric acid and also inorganic phosphonic acids, for example the neutral sodium salts of 1-hydroxyethane-1,1-diphosphonate, which can be present in amounts of 0.5% to 5%, preferably 1% to 2% by weight. Useful viscosity regulators include for example hydrogenated castor oil, salts of long-chain fatty acids, which are preferably used in amounts of 0% to 5% by weight and especially in amounts of 0.5% to 2% by weight, examples being sodium, potassium, aluminum, magnesium and titanium stearates or the sodium and/or potassium salts of behenic acid, and also further polymeric compounds. The latter preferably include polyvinylpyrrolidone, urethanes and the salts of polymeric polycarboxylates, for example of homopolymeric or copolymeric polyacrylates, polymethacrylates and especially copolymers of acrylic acid with maleic acid, preferably those comprising 50% to 10% of maleic acid. The relative molecular mass of homopolymers is generally between 1000 and 100 000 and of copolymers between 2000 and 200 000, preferably between 50 000 to 120 000, based on the free acid. Also of particular usefulness are the water-soluble polyacrylates that are crosslinked with about 1% of a polyallyl ether of sucrose for example and that have a relative molecular mass above one million. Crosslinked polyacrylates are preferably used in amounts not exceeding 1% by weight, preferably in amounts of 0.2% to 0.7% by weight. The compositions may additionally contain about 5% to 20% by weight of a partially esterified copolymer. These partially esterified polymers are obtained by copolymerization of (a) at least one C4-C28 olefin or mixtures of at least one C4-C28 olefin with up to 20 mol% of C1-C28 alkyl vinyl ethers and (b) ethylenically unsaturated dicarboxylic anhydrides having 4 to 8 carbon atoms in a molar ratio of 1:1 to form copolymers having K values in the range from 6 to 100 and subsequent partial esterification of the copolymers with reaction products such as C1-C13 alcohols, C8-C22 fatty acids, C1-C12 alkylphenols, secondary C2-C30 amines or mixtures thereof with at least one C2-C4 alkylene oxide or tetrahydrofuran and also hydrolysis of the anhydride groups of the copolymers to carboxyl groups, wherein the partial esterification of the copolymers is carried on until 5 to 50% of the carboxyl groups of the copolymers are esterified. Preferred copolymers contain maleic anhydride as ethylenically unsaturated dicarboxylic anhydride. The partially esterified copolymers may be either in the form of the free acid or, preferably, in partially or fully neutralized form. Advantageously, the copolymers are used in the form of an aqueous solution, especially in the form of a 40% to 50% by weight solution. The copolymers not only contribute to the primary and secondary detergency of the liquid laundry detergent and cleaning product, but also effectuate a desired reduction in the viscosity of the concentrated liquid laundry detergent. Using these partially esterified copolymers provides concentrated aqueous liquid laundry detergents that will flow under the influence of gravity alone and without application of other shearing forces. The partially esterified copolymer content of concentrated aqueous liquid laundry detergents is preferably in the range from 5% to 15% by weight and especially in the range from 8% to 12% by weight.

Useful enzymes include enzymes from the class of proteases, lipases, amylases, cellulases and/or mixtures thereof. Enzymatically active ingredients isolated from bacterial strains or fungi, such as Bacillus subtilis, Bacillus licheniformis or Streptomyces griseus are particularly suitable. Preference is given to using proteases of the subtilisin type and especially proteases isolated from Bacillus lentus. Their proportion can be about 0.2% to about 2% by weight. Enzymes can be adsorbed on support substances and/or embedded in envelope substances in order that they may be protected against premature decomposition. In addition to the mono- and polyfunctional alcohols and the phosphonates, the compositions may contain further enzyme stabilizers. Sodium formate can be used at 0.5% to 1% by weight for example. It is also possible to use proteases stabilized with soluble calcium salts and a calcium content of preferably about 1.2% by weight, based on the enzyme. However, it is particularly advantageous to use boron compounds, for example boric acid, boron oxide, borax and other alkali metal borates.

Useful soil repellants (soil-repellant polymers) include those which preferably contain ethylene terephthalate and/or polyethylene glycol terephthalate groups, in which case the molar ratio of ethylene terephthalate to polyethylene glycol terephthalate can be in the range from 50:50 to 90:10. The molecular weight of linking polyethylene glycol units is especially in the range from 750 to 5000, i.e., the degree of ethoxylation of polymers comprising polyethylene glycol groups can be about 15 to 100. The polymers are notable for an average molecular weight of about 5000 to 200 000 and may have a block structure but preferably have a random structure. Preferred polymers have ethylene terephthalate/polyethylene glycol terephthalate molar ratios of about 65:35 to about 90:10, preferably of about 70:30 to 80:20. Preference is further given to polymers comprising linking polyethylene glycol units with a molecular weight of 750 to 5000, preferably in the range from 1000 to about 3000, and having a molecular weight of about 10 000 to about 50 000 for the polymer.

For use in mechanical laundering processes, it may be advantageous to add customary foam inhibitors to the compositions. Suitable for this purpose are for example soaps of natural or synthetic origin, which have a high proportion of C18-C24 fatty acids. Suitable nonsurfactant foam inhibitors include, for example, organopolysiloxanes and mixtures thereof with microfine, optionally silanized silica, and also paraffins, waxes, microcrystalline waxes and mixtures thereof with silanized silica or bistearylethylenediamide. Mixtures of various foam inhibitors are also used with advantages, for example mixtures of silicones, paraffins or waxes. The foam inhibitors, especially silicone- or paraffin-containing foam inhibitors, are preferably bound to a granular support substance that is soluble/dispersible in water. Mixtures of paraffins and bistearylethylenediamides are especially preferable.

The scents and perfumes, which may be in solid form but are preferably in liquid form, are in some instances complex mixtures of various individual chemical compounds known as scents. Scents can be selected from a wide variety of chemical classes. A distinction can be made between alkali-stable and less alkali-stable scents. The use of perfumes/scents in or together with the wax dispersions used according to the invention may be preferable. In this case, the scent or perfume content can vary between 0.01% and 15% by weight, although contents between 1.0% and 10% by weight and especially 1.5% to 6% by weight (all based on the total weight of the wax dispersion or of the laundry detergent) are preferable.

The pH of the present and especially preferred concentrated compositions is generally in the range from 7 to 10.5, preferably in the range from 7 to 9.5 and especially in the range from 7 to 8.5. Higher pH values, for example above 9, can be set by using small amounts of aqueous sodium hydroxide solution or of alkaline salts such as sodium carbonate or sodium silicate. The liquid laundry detergents according to the invention generally have viscosities between 150 and 10 000 mPas (Brookfield viscometer, spindle 1, 20 revolutions per minute, 20° C.)

However, it is particularly advantageous that the compositions according to the invention are easily formulatable/useable together with anionic surfactants. Typical examples of anionic surfactants are soaps, alkylbenzensulfonates, alkanesulfonates, olefinsulfonates, alkyl ether sulfonates, glycerol ether sulfonates, α-methyl ester sulfonates, sulfo fatty acids, alkyl sulfates, fatty alcohol ether sulfates, glycerol ether sulfates, fatty acid ether sulfates, hydroxy mixed-ether sulfates, monoglycerides (ether)sulfates, fatty acid amide (ether)sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, for example acyl lactylates, acyl tartrates, acyl glutamates and acyl aspartates, alkyloligoglucoside sulfates, protein fatty acid condensates (especially vegetable products based on wheat) and alkyl (ether)phosphates. When anionic surfactants contain polyglycol ether chains, these may have a conventional homolog distribution, but preferably have a narrowed homolog distribution.

### EXAMPLES

### 1) Laundering Tests with Subsequent Measurement of Rupturing Behavior by Grab Method

2500 g of cotton laundry which, in addition to the ballast laundry, also contained a standardized species of woven fabric (wfk 10A) was washed twenty times in succession with 100 g each time of a light duty laundry detergent A, containing a mixture of anionic and nonionic surfactants, at 40° C. in a commercially available domestic washing machine (Miele Softronic W 3527). The standardized fabric was subsequently removed and line dried. The dry fabric was hot-pressed with a commercially available steam iron and cut in accordance with DIN EN ISO 13934-2, i.e., having regard to warp and weft directions. The cut fabric specimens were each then clamped in the warp direction into a Zwick machine and subjected to a measurement of the maximum tensile force by the grab method in accordance with DIN EN ISO 13934-2. The measurement was repeated five times.

For comparison, the same test was carried out using a light duty laundry detergent B which contained the same mixture of anionic and nonionic surfactants as the light duty laundry detergent A, but additionally also 3% by weight of Plantatex® HCC from Cognis.

The Plantatex® HCC was added by simply stirring the aqueous wax dispersion into the light duty laundry detergent at room temperature.

Again, the same measurements for determining the maximum tensile force were carried out according to DIN EN ISO 13934-2 (grab method) and compared.

After the laundering tests, the level of wax on the dry textiles was analyzed by extraction and subsequent gas chromatography to assess the efficacy of the wax. A wax content<5 ppm was found on the original (V) and the textiles washed with light duty laundry detergent A (1A). The textiles washed with light duty laundry detergent B(1B) were found to have a wax content of 48 ppm.

Table 1 which follows shows these values for comparison with the average values of the maximum tensile force (+/−standard deviation).

TABLE 1

| | | Light duty | Light duty |
|---|---|---|---|
| | Original wfk | laundry | laundry |
| | 10A | detergent A | detergent B |
| laundering test | V | 1A | 1B |
| wax content | <5 | <5 | 48 |
| [ppm] | | | |
| maximum tensile | 556.1 +/− 51.9 | 471.8 +/− 19.1 | 519.5 +/− 39.2 |
| force [N] +/− | | | |
| standard | | | |
| deviation | | | |

A significant (2-sided T-test>95%) improvement in maximum tensile force is observed here for the textiles washed with light duty laundry detergent B, i.e., with inclusion of the wax dispersion.

### 2) Laundering Tests with Subsequent Measurement of Tear Behavior by Elmendorf Method

2500 g of cotton laundry which, in addition to the ballast laundry, also contained a standardized species of woven fabric (wfk 10A) was washed twenty times in succession with 100 g each time of the light duty laundry detergent A from test 1, containing a mixture of anionic and nonionic surfactants, at 40° C. in a commercially available domestic washing machine (Miele Softronic W 3527). The standardized fabric was subsequently removed and line dried.

The dry fabric was hot-pressed with a commercially available steam iron and cut in accordance with DIN EN ISO 13937-1 (Determination of tear force using ballistic pendulum method (Elmendorf)) i.e., having regard to warp and weft directions. The cut fabric specimens were then each subject to the determination of the tear force by the Elmendorf method in accordance with DIN EN ISO 13937-1 in the warp or weft direction. The measurement was repeated five times.

For comparison, the same test was carried out using the light duty laundry detergent B which contained the same mixture of anionic and nonionic surfactants as the light duty laundry detergent A, but additionally also 3% by weight of Plantatex® HCC from Cognis. The Plantatex® HCC was added by simply stirring the aqueous wax dispersion into the light duty laundry detergent at room temperature.

The same test was further carried out with the light duty laundry detergent C, which contained a mixture of cationic and nonionic surfactants and additionally also 0.15% by weight of a wax consisting of a diol ester.

A laundering test was further carried out with the light duty laundry detergent D, which contained the same mixture of cationic and nonionic surfactants as the light duty laundry detergent C, but additionally also 3% by weight of Plantatex® HCC from Cognis. The Plantatex® HCC was added by simply stirring the aqueous wax dispersion into the light duty laundry detergent at room temperature.

Again, following similar drying of the textiles, the same measurements were carried out to determine the maximum tensile force according to DIN EN ISO 13937-1 and compared with each other. After the laundering tests, the level of wax on the dry textiles was analyzed by extraction and subsequent gas chromatography to assess the efficacy of the wax.

The following average values were determined according to DIN EN ISO 13937-1 (Determination of tear force using ballistic pendulum method (Elmendorf)) for the tear force (+/−standard deviation) in the warp and weft directions (Table 2):

TABLE 2

| | Original wfk | Light duty | Light duty | Light duty | Light duty |
|---|---|---|---|---|---|
| | 10A | laundry | laundry | laundry | laundry |
| | (prewashed) | detergent A | detergent B | detergent C | detergent D |
| laundering | V | 2A | 2B | 2C | 2D |
| test | | | | | |
| wax content | <5 | <5 | 48 | 530 | 2400 |
| on dried | | | | | |
| textiles | | | | | |
| [ppm] | | | | | |
| tear force - | 10.94 +/− 0.83 | 9.04 +/− 0.16 | 9.86 +/− 0.53 | 17.9 +/− 1.63 | 20.6 +/− 0.71 |
| warp [N] +/− | | | | | |
| standard | | | | | |
| deviation | | | | | |
| tear force - | 9.28 +/− 0.23 | 9.71 +/− 0.17 | 10.24 +/− 0.75 | 18.1 +/− 0.78 | 18.7 +/− 1.51 |
| weft [N] +/− | | | | | |
| standard | | | | | |
| deviation | | | | | |

It is apparent that using light duty laundry detergent B provides a significant (2-sided T-test>95%) improvement in tear force, which increases even further on using light duty laundry detergent C or D to provide a higher concentration of wax on the textiles.

### 3) Laundering Tests with Subsequent Measurement of Tear Behavior by Elmendorf Method

2500 g of laundry which, in addition to the ballast laundry composed of cotton, also contained multiple standardized, prewashed species of woven fabric composed of cotton and/or polyester (wfk 10A: 100% cotton; wfk 20A: 65% polyester, 35% cotton; wfk 30A: 100% polyester) was washed ten times in succession with 75 g each time of a light duty laundry detergent containing a mixture of anionic and nonionic surfactants at 40° C. in a commercially available domestic washing machine (Miele Softronic® W 3527). The standardized fabric was subsequently removed and line dried.

The dry and cotton-containing fabric was hot-pressed with a commercially available steam iron and cut according to DIN EN ISO 13937-1 (Determination of tear force using ballistic pendulum method (Elmendorf)), i.e., having regard to warp and weft directions. The cut fabric specimens were subsequently subjected to an Elmendorf determination of the tear force of the warp threads in accordance with DIN EN ISO 13937-1. The measurement was repeated six times.

For comparison, three further series of measurements were carried out using the same type and amount of light duty laundry detergent, but this time with addition of 5% by weight of Polyquart® CCE polyolefin wax dispersion from Cognis. This concentration would correspond to an add-on level of 300 ppm. The third and fourth series of measurements additionally included 1.25% by weight of Polyquart® PRO amphoteric polymer from Cognis and 1% by weight of Dehyquart® A cationic surfactant from Cognis, respectively. The additions were done by simply stirring the aqueous dispersion or solutions into the light duty laundry detergent at room temperature. The following average values (units in [N]) were determined for the tear force (+/−standard deviation) in accordance with DIN EN ISO 13937-1 (Determination of tear force using ballistic pendulum method (Elmendorf)) (Table 3):

TABLE 3

| | | | | | Light | |
|---|---|---|---|---|---|---|
| | | | | | duty | Light |
| | | | | | laundry | duty |
| | | | | | detergent + | laundry |
| | | | | Light | 5 wt % | detergent + |
| | | | | duty | of | 5 wt % |
| | | | | laundry | Polyquart | of |
| | | | | detergent + | CCE + | Polyquart |
| | | | Light | 5 wt % | 1.25 wt % | CCE + |
| | Original | Original | duty | of | of | 1.00 wt % |
| | (wfk | (pre- | laundry | Polyquart | Polyquart ® | of |
| | fabric) | washed) | detergent | CCE | PRO | Dehyquart ® A |
| wfk 10 A | 17.45 +/− 0.27 | 11.12 +/− 0.32 | 10.33 +/− 0.19 | 10.50 +/− 0.21 | 10.65 +/− 0.34 | 10.25 +/− 0.18 |
| wfk 20 A | 48.70 +/− 1.7 | 23.77 +/− 0.67 | 24.57 +/− 1.40 | 25.93 +/− 0.81 | 43.82 +/− 0.99 | 27.15 +/− 0.70 |
| wfk 30 A | 85.12 +/− 4.1 | 38.88 +/− 1.12 | 40.61 +/− 0.97 | 42.36 +/− 1.47 | 73.90 +/− 4.54 | 40.13 |
| | | | | | | 1.01 |

It is apparent that especially the use of an admixture of the light duty laundry detergent with a combination of polyolefin wax and an amphoteric polymer provides a significant improvement in tear force on the polyester-containing fabrics, which almost reaches the tear force level of the original fabric.

For comparison, the Polyquart CCE was forcibly applied to the textile, via a padding method, from an aqueous application solution which did not contain any light duty laundry detergent. For this, the concentration of Polyquart CCE in the liquor was adjusted such that, after padding, there was a concentration of polyolefin wax on the textile of 50, 100 and 500 ppm. Thereafter, the tear force of the warp threads (in [N]) was determined as described above.

TABLE 4

| | Original | | 50 ppm of | 100 ppm of | 500 ppm of |
|---|---|---|---|---|---|
| | (wfk | Original | polyolefin | polyolefin | polyolefin |
| | fabric) | (prewashed) | wax | wax | wax |
| wfk 10 A | 16.88 +/− 0.37 | 11.15 +/− 0.28 | 12.41 +/− 1.12 | 13.53 +/− 0.78 | 21.23 +/− 0.80 |
| wfk 20 A | 51.23 +/− 2.02 | 23.65 +/− 0.69 | 49.11 +/− 3.33 | 51.06 +/− 1.12 | 56.98 +/− 1.68 |

1. A method for improving the mechanical properties of textile fibers, the method comprising applying to the textile fibers aqueous compositions comprising, in addition to water, at least a dispersant (a) and a wax component (b) and optionally auxiliary and added substances (c).

2. The method according to claim 1, wherein the dispersant component (a) is selected from alkyl(oligo)glycosides and the waxes (b) are selected from a mixture of mono- and diesters of saturated and unsaturated fatty acids having 16 to 22 carbon atoms with diols and polyols.

3. The method according to claim 2, wherein the fatty acids are selected from palmitic/stearic acids and palmitic, stearic, and oleic acid, and the diols and polyols are selected from ethylene glycol and glycerol.

4. The method according to claim 1, wherein the wax component (b) is selected from dispersible polyolefins.

5. The method according to claim 1, wherein the auxiliary and added substances (c) are selected from diols and/or polyols.

6. The method according to at claim 1, wherein the auxiliary and added substances (c) are selected from polymers having cationic, anionic or nonionic monomers.

7. The method according to claim 1, wherein the auxiliary and added substances (c) are cationic compounds.

8. The method according to claim 1, wherein the compositions contain water in amounts of 1% to 99% by weight.

9. The method according to claim 1, wherein the compositions contain the components (a) and (b) together in an amount of 0.1% to 15% by weight.

10. The method according to claim 1, wherein the components (a) and (b) are present side by side in a weight ratio of 1:3 to 3:1.

11. The method according to claim 1, wherein the wax composition is used together with a laundry detergent.

12. The method according to claim 1, wherein the composition is applied to the textile fibers more than once.

13. The method according to claim 1, wherein the fibers are endowed with a wax quantity of 10 to 1000 ppm.

14. The method of claim 1 wherein the composition reduces the tear tendency of the textile fibers.

15. The method of claim 1 wherein the composition increases the tensile strength of the textile fibers.

16. The method of claim 4, wherein the dispersible polyolefins are oxidized polyolefins.

17. The method of claim 5, wherein diols and/or polyols are selected from glycerol, glycol and polyethylene glycol.

18. The method of claim 6, wherein polymers are selected from amphoteric polymers.

19. The method of claim 7, wherein the cationic compounds are quaternized ammonium compounds.

20. The method according of claim 1, wherein the compositions contain water in amounts of 40% to 90% by weight.
